(19) United States
(12) Patent Application Publication
(10) Pub. No.: US 2010/0089993 A1
(43) Pub. Date: Apr. 15, 2010

(54) APPARATUS AND METHOD FOR COLLECTING SHOPPING INFORMATION USING MAGNETIC SENSOR

(75) Inventors: Chang-Sub Shin, Daejon (KR); In-Hwan Lee, Daejon (KR); Bong-Soo Kim, Daejon (KR); Cheol-Sig Pyo, Daejon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejon (KR)

(21) Appl. No.: 12/517,543

(22) PCT Filed: Oct. 24, 2007
(86) PCT No.: PCT/KR07/05257

§ 371 Date: Jun. 3, 2009

(30) Foreign Application Priority Data
Dec. 4, 2006 (KR) 10-2006-0121216
Aug. 27, 2007 (KR) 10-2007-0086164

(51) Int. Cl. G06Q 99/00

(52) U.S. Cl. 235/375

(57) ABSTRACT

Provided are an apparatus and method for collecting shopping information using a magnetic sensor. The shopping information collecting apparatus, includes: a magnetic value sensing and analyzing means for sensing and analyzing a magnetic value within own zone in real-time; a central processing means for processing shopping information based on the magnetic value analyzed by the magnetic value sensing and analyzing means; and a shopping information transmitting means for transmitting shopping information processed by the central processing means.

### TECHNICAL FIELD

The present invention relates to an apparatus and method for collecting shopping information using a magnetic sensor; and, more particularly, to a shopping information collecting apparatus and method for efficiently managing a store at low installation and maintenance costs by collecting shopping information using a magnetic sensor.

This work was supported by the IT R&D program for MIC/IITA [2005-S-038-02, “Development of UHF RF-ID and Ubiquitous Networking Technology”].

### BACKGROUND ART

Recently, researches on ubiquitous networking and ubiquitous computing have been actively progressed. Also, a technology for automatically and wirelessly recognizing a location of an object and grasping a route, and development of a system using the technology become a public issue.

Herein, a ubiquitous environment means an environment that a user can receive a required computing service anytime and anywhere. In particular, since Radio Frequency Identification (RFID) is realistically adaptable to a shopping center and large stores, a field related to collection and analysis of shopping information has been remarkably developed.

A representative technology for collecting and analyzing the shopping information includes a technology for collecting and processing customers' shopping information by recognizing a shopping cart with an RFID tag through an RFID reader installed at every predetermined section inside the store.

### DISCLOSURE

### Technical Problem

The conventional technology does not efficiently manage a system since it costs a lot to install and maintain shopping carts and a plurality of Radio Frequency Identification (RFID) readers and tags inside a store, and an object of the present invention is to solve the above problem.

Therefore, an embodiment of the present invention is directed to providing a shopping information collecting apparatus and method for efficiently managing a store at low installation and maintenance costs by collecting shopping information using a magnetic sensor.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided an apparatus for collecting shopping information, including: a magnetic value sensing and analyzing means for sensing and analyzing a magnetic value within own zone in real-time; a central processing means for processing shopping information based on the magnetic value analyzed by the magnetic value sensing and analyzing means; and a shopping information transmitting means for transmitting shopping information processed by the central processing means.

The apparatus of the present invention further includes: a Real Time Clock (RTC) processing means for providing store open and close time information; and a power control means for controlling power based on open and close time information from the RTC processing means.

The apparatus of the present invention further includes: a data storing means for storing shopping information processed by the central processing means.

In accordance with another aspect of the present invention, there is provided a method for collecting shopping information, including the steps of: initializing pre-processed shopping information; checking whether a shopping cart stops within own zone based on a magnetic value sensed in real-time and collecting information on the shopping cart; and transmitting the collected shopping information.

The method of the present invention, further including the steps of: converting a mode into a normal mode based on store open time information and going to the step of initializing the pre-processed shopping information; and converting a mode into a sleep mode based on store close time information.

The method of the present invention, further including the step of: storing the collected shopping information.

### Advantageous Effects

As described above, the present invention can reduce costs for system installation by collecting shopping information using a magnetic sensor.

Also, the present invention can be easily and efficiently managed by installing a shopping information collecting apparatus in a product display stand without additional work except attaching a magnet to a shopping cart.

Also, the present invention can save power by transmitting forwarding data transmitted from a child node with sensing information collected by the present invention.

### BRIEF DESCRIPTION OF THE DRAWINGS

FIG. 1 shows a shopping information collecting and analyzing system to which the present invention is applied.

FIG. 2 is a block diagram showing a shopping information collecting apparatus in accordance with an embodiment of the present invention.

FIG. 3 is a flowchart describing a method for calculating the number of shopping carts and a possessing time of the shopping cart in accordance with an embodiment of the present invention.

FIG. 4 is a flowchart describing a power control method in accordance with an embodiment of the present invention.

FIG. 5 is a flowchart describing a shopping information collecting method in accordance with an embodiment of the present invention.

### BEST MODE FOR THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

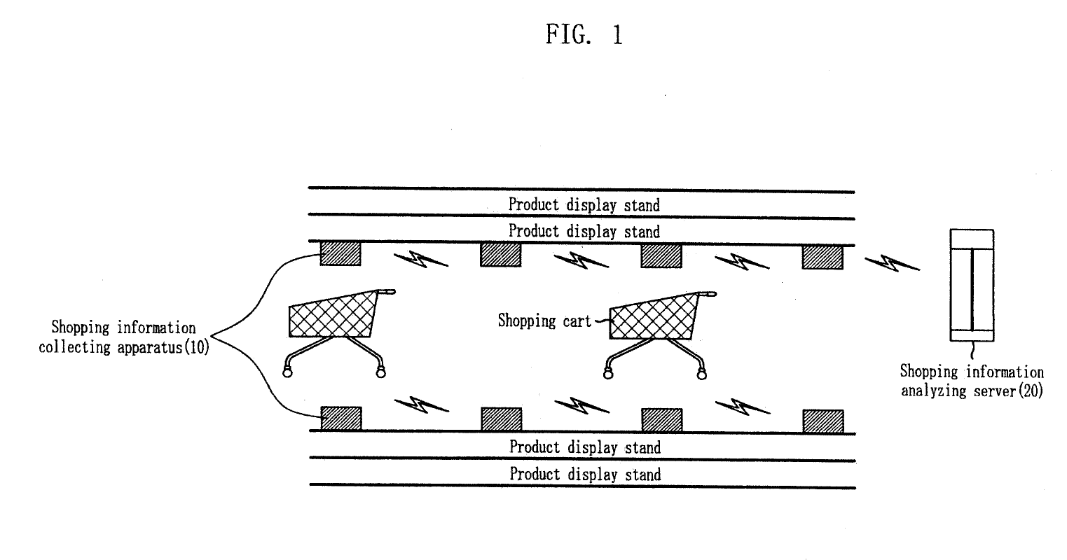

FIG. 1 shows a shopping information collecting and analyzing system to which the present invention is applied.

Referring to FIG. 1, the shopping information collecting and analyzing system to which the present invention is applied includes a shopping information collecting apparatus 10 and a shopping information analyzing server 20. The shopping information collecting and analyzing system may further include a repeater (not shown).

The shopping information collecting apparatus 10 recognizes the number of shopping carts within a predetermined zone using a magnetic sensor. The shopping information collecting apparatus 10 installed at an entrance of the store recognizes the number of carts entering the store, i.e., the number of entire customers. The shopping information collecting apparatus 10 installed at a product display stand at a predetermined interval collects shopping information, i.e., information on the number of staying shopping carts in a predetermined zone, a possessing time and a use time of the shopping cart.

Also, the shopping information collecting apparatus 10 transmits the collected shopping information to the shopping information analyzing server 20 through a route set up when the system is built based on network shape information.

The shopping information collecting apparatus 10 modifies the shopping information into shopping information of a format corresponding to a pre-defined communication protocol and transmits the modified shopping information. That is, the shopping information collecting apparatus 10 transmits the modified shopping information through a data framing technology.

When there is a child node of the shopping information collecting apparatus 10, the shopping information collecting apparatus 10 collects shopping information (forwarding data), which is collected by the child node, from the child node, and combines the shopping information with the shopping information collected by the shopping information collecting apparatus 10 itself. The shopping information collecting apparatus 10 transmits the combined shopping information to a neighboring parent node when there is a parent node, to the repeater when there is no parent node but there is the repeater, or to the shopping information analyzing server 20 when there is no parent node or repeater but there is the shopping information analyzing server.

The repeater repeats the shopping information when the shopping information collecting apparatus 10 is not able to directly transmit the shopping information to the shopping information analyzing server 20 due to a long distance between the shopping information collecting apparatus 10 and the shopping information analyzing server 20.

The shopping information analyzing server 20 analyzes the shopping information transmitted from the shopping information collecting apparatus 10 or the repeater, and processes the shopping information according to a service of diverse objects.

For example, the shopping information analyzing server 20 calculates a congestion time zone, and an average selection time and popularity of each product by customers base on shopping information of the analyzed customer and uses the calculated results for efficient store management. However, the present invention is not limited to that.

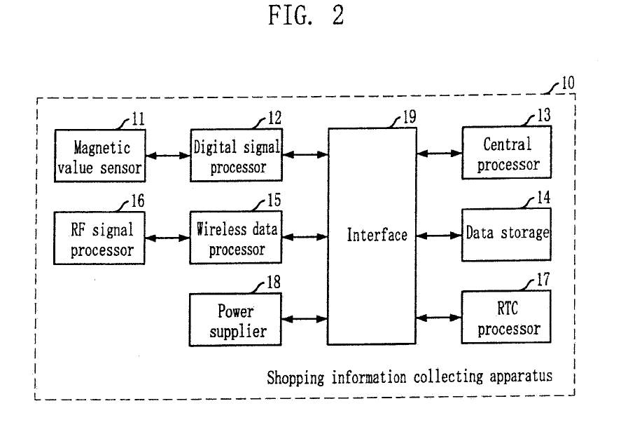

The shopping information collecting apparatus 10 of the shopping information collecting and analyzing system will be described in detail with reference to FIG. 2.

FIG. 2 is a block diagram showing the shopping information collecting apparatus in accordance with an embodiment of the present invention.

FIG. 2 will be described on the basis of the shopping information collecting apparatus 10 installed at a predetermined interval in the product display stand of the store.

Referring to FIG. 2, the shopping information collecting apparatus 10 in accordance with the present invention includes a magnetic value sensor 11, a digital signal processor 12, a central processor 13, a data storage 14, a wireless data processor 15, an RF signal processor 16, a Real Time Clock (RTC) processor 17, a power supplier 18, and an interface 19.

The magnetic value sensor 11 is a magnetic sensor for sensing a magnetic value in real-time due to appearance of the shopping cart within a zone of the magnetic value sensor 11, converting a changed magnetic value into a digital signal when the magnetic value is changed, and transmits the digital signal to the digital signal processor 12.

A zone that the magnetic value sensor 11 can sense the magnetic value is pre-set up in order not to be overlapped with a zone where the magnetic value sensor 11 of a neighboring shopping information collecting apparatus 10 can sense the magnetic value.

The digital signal processor 12 analyzes the digital signal, i.e., the magnetic value, transmitted from the magnetic value sensor 11 and transmits the digital signal to the central processor 13 through the interface 19.

When the magnetic value analyzed by the digital signal processor 12 exceeds a predetermined threshold, the central processor 13 determines that a shopping cart appears in the zone.

The central processor 13 can recognize the number of shopping carts simultaneously appearing based on the threshold defined individually according to the number of shopping carts. A related example will be described in detail with reference to Table 1.

TABLE 1

| | Number of shopping |
|---|---|
| Threshold | carts |
| Greater than 10 | 1 |
| Greater than 20 | 2 |
| Greater than 30 | 3 |
| . | . |
| . | . |
| . | . |

When the magnetic value greater than 10 is sensed, the central processor 13 determines that one shopping cart appears. When the magnetic value greater than 20 is sensed, the central processor 13 determines that two shopping carts appear. When the magnetic value greater than 30 is sensed, the central processor 13 determines that three shopping carts appear.

Table 1 shows an example of the threshold defined individually according to the number of shopping carts but the present invention is not limited to the example.

When a magnetic value greater than the threshold is sensed continuously more than predetermined times, e.g., greater than 5, the central processor 13 determines that a shopping cart stops within a predetermined zone in order to raise exactness in sensing of the magnetic value.

For example, the central processor 13 senses a magnetic value every 1 second and determines that the shopping cart stops within a predetermined zone when the same magnetic value is sensed continuously more than 5 times, i.e., when the same magnetic value is continuously sensed for 5 seconds. When the same magnetic value is sensed less than 5 times, i.e., when the same magnetic value is not continuously sensed for 5 seconds, the central processor 13 determines that the shopping cart passes by the corresponding zone without stopping.

When the shopping cart is located in a place where two magnetic value sensors 11 can doubly sense, the central processor 13 determines that only the magnetic value sensor 11 sensing the greater magnetic value among two magnetic value sensors 11 senses the magnetic value of the shopping cart.

For example, when a value greater than a half value of the pre-determined threshold is sensed, the magnetic value sensor 11 determines that a high magnetic value is sensed. When a value smaller than a half value of the pre-determined threshold is sensed, the magnetic value sensor 11 determines that a low magnetic value is sensed. However, the present invention is not limited to the example.

Also, when it is determined that the shopping cart stops within a predetermined zone, the central processor calculates from a start time to an end time for sensing the magnetic value by the magnetic value sensor 11 and outputs a possessing time and a usage time zone of the shopping cart based on the calculated result.

Also, the central processor 13 transmits the processed shopping information such as the number of shopping carts, and the possessing time and the usage time zone of the shopping cart, to the wireless data processor 15 through the interface 19. The central processor 13 additionally transmits the processed shopping information to the data storage 14.

The data storage 14 stores the shopping information additionally processed by the central processor 13.

The wireless data processor 15 transmits the shopping information transmitted from the central processor 13 through the interface 19 to the RF signal processor 16.

When the wireless data processor 15 receives the shopping information, i.e., the forwarding data, of the child node from the RF signal processor 16, the wireless data processor 15 combines the received forwarding data and the shopping information transmitted from the central processor 13, and transmits the combined forwarding data and shopping information to the RF signal processor 16.

When the RF signal processor 16 receives the shopping information (forwarding data) from the neighboring shopping information collecting apparatus 10, i.e., the child node, the RF signal processor 16 converts the received forwarding data into a digital signal, transmits the digital signal to the wireless data processor 15, converts the shopping information transmitted from the wireless data processor 15 into an analog signal, and transmits the analog signal to own parent node, the repeater or the shopping information analyzing server 20.

Additionally, the RTC processor 17 provides information on open and close times of the store to the power supplier 18 through the interface 19 in order to increase a life span of a battery and save power.

Accordingly, a mode of the power supplier 18 is converted into a normal mode at the open time of the store provided from the RTC processor 17 and into a sleep mode at the close time of the store provided from the RTC processor 17.

Although the mode of the power supplier 18 is converted into the sleep mode and other modules do not operate, the RTC processor 17 continuously operate in order to provide open time information of the store.

The interface 19 provides an interface between the modules such that the digital signal processor 12, the central processor 13, the data storage 14, the wireless data processor 15, the RTC processor 17, and the power supplier 18 can communicate with one another.

A configuration of the shopping information collecting apparatus 10 installed at the store entrance is the same as a configuration of the shopping information collecting apparatus 10 installed at the product display stand of the store as shown in the FIG. 2. The central processor 13 of the shopping information collecting apparatus 10 installed at the product display stand of the store calculates the number of shopping carts, and the possessing time and the usage time zone of the shopping cart. On the other hand, the central processor 13 of the shopping information collecting apparatus 10 installed at the store entrance calculates only the number of shopping carts entering the store, i.e., the number of entire customers.

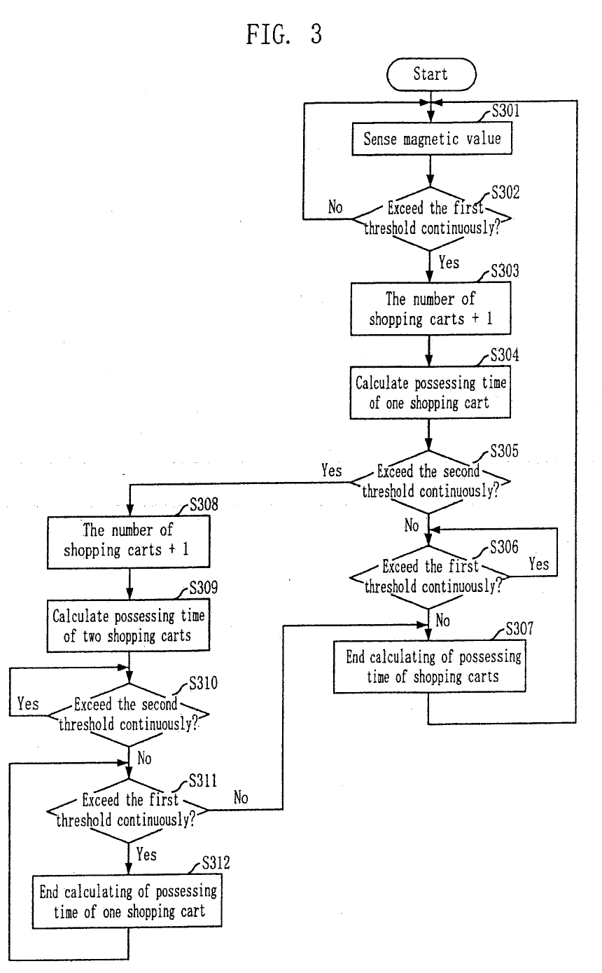

FIG. 3 is a flowchart describing a method for calculating a possessing time of the shopping cart and the number of shopping carts in accordance with an embodiment of the present invention.

FIG. 3 will be described under assumption that the number of shopping carts which can be recognized by the same shopping information collecting apparatus 10 is maximally 2.

The shopping information collecting apparatus 10 senses a magnetic value within own zone in real-time at step S301.

In order to recognize whether the shopping cart stops within the zone, the shopping information collecting apparatus 10 determines that one shopping cart stops in the zone when a sensed magnetic value exceeds a pre-defined first threshold continuously more than predetermined times, e.g., 5 times, at step S302, adds 1 to the number of shopping carts at step S303, and calculates a possessing time of one shopping cart at step S304.

The first threshold denotes a magnetic value of one shopping cart.

In order to check whether another shopping cart stops within the zone, the shopping information collecting apparatus 10 checks in real-time at step S305 whether the sensed magnetic value exceeds a pre-defined second threshold more than the predetermined times, e.g., 5 times.

The second threshold denotes a magnetic value of two shopping carts.

At a check result of the step S305, when the sensed magnetic value does not exceed the second threshold continuously more than predetermined times, the shopping information collecting apparatus 10 determines that two shopping carts do not stop within the zone, i.e., that only one shopping cart stops within the zone. In order to check whether the shopping cart stopped within the zone goes out, the shopping information collecting apparatus 10 checks in real-time at step S306 whether the sensed magnetic value exceeds the first threshold continuously more than a predetermined time.

At a check result of the step S306, when the sensed magnetic value does not exceed the first threshold continuously more than predetermined times, the shopping information collecting apparatus 10 determines that the shopping cart goes out the zone, ends calculating of the possessing time of the shopping cart at the step S304 at step S307, goes to the procedure of the step S301, and senses again the magnetic value within the zone in real-time.

At a check result of the step S305, the sensed magnetic value exceeds the second threshold continuously more than predetermined times, the shopping information collecting apparatus 10 determines that two shopping carts stop within the zone, adds 1 to the number of shopping carts at step S308, and calculates a possessing time of two shopping carts at step S309.

The shopping information collecting apparatus 10 can calculate from the stopping time of the second shopping cart within the zone to the possessing time of two shopping carts by doubling the possessing time of the shopping cart calculated in the step S304 as an example of calculating the possessing time of two shopping carts. The example does not limit the present invention.

In order to check whether two shopping carts stopping within the zone go out, the shopping information collecting apparatus 10 checks at step S310 whether the sensed magnetic value exceeds the second threshold continuously more than predetermined times.

At a check result of the step S310, when the sensed magnetic value does not exceed the second threshold continuously more than predetermined times, the shopping information collecting apparatus 10 checks in real-time at step S311 in order to recognize the number of shopping carts going out of the zone whether the sensed magnetic value exceeds the first threshold continuously more than predetermined times.

At a check result of the step S311, when the sensed magnetic value exceeds the first threshold continuously more than predetermined times, the shopping information collecting apparatus 10 determines that only one shopping cart goes out of the zone, ends calculating of the possessing time of the shopping cart going out of the zone at step S312, and goes to the step S311 in order to check whether rest shopping carts go out of the zone.

When the shopping information collecting apparatus ends calculating of the possessing time of the shopping cart going out of the zone, the shopping information collecting apparatus 10 calculates only the possessing time of one shopping cart from the time that one shopping cart goes out of the zone, identically with the step S304.

At a check result of the step S311, when the sensed magnetic value does not exceed the first threshold continuously more than predetermined times, the shopping information collecting apparatus 10 determines that a rest shopping cart goes out the zone and ends calculating of the possessing time of the shopping cart at step S307.

Although it is assumed in FIG. 3 for the sake of convenience in explanation that the maximum number of shopping carts recognizable by the same shopping information collecting apparatuses 10 is 2, the present invention is not limited to this and the method of FIG. 3 may be applied to more than 3 shopping carts.

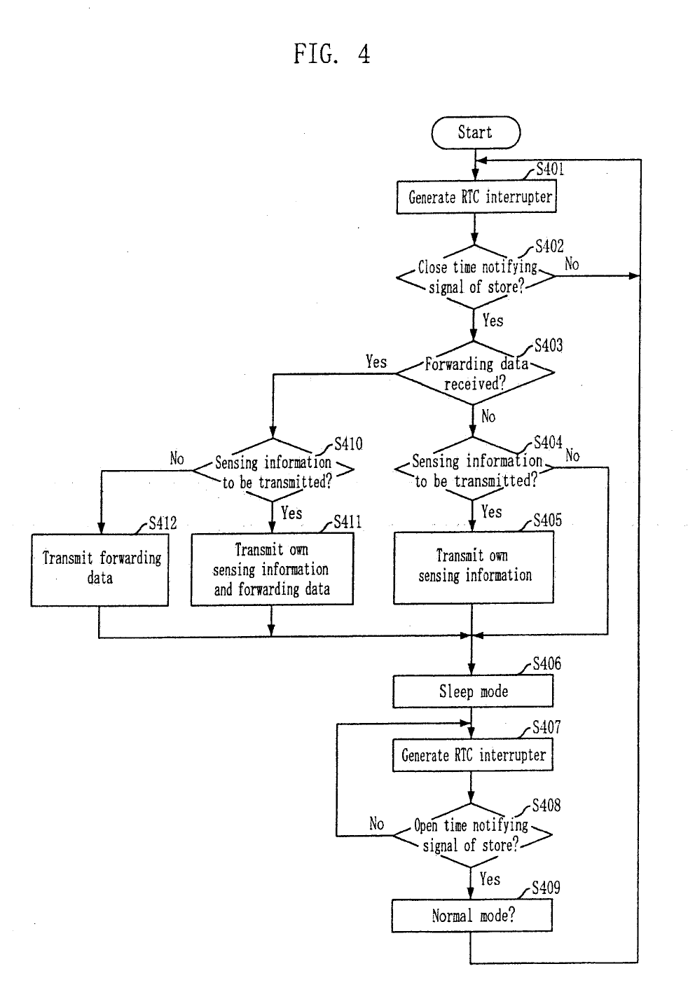

FIG. 4 is a flowchart describing a power control method in accordance with an embodiment of the present invention and shows a method that the shopping information collecting apparatus 10 converts a mode between a normal mode and a sleep mode.

When an RTC interrupter is generated at step S401, the shopping information collecting apparatus 10 checks whether the RTC interrupter is a close time notifying signal of the store at step S402.

At a check result of step S402, when it is not the close time notifying signal of the store, the shopping information collecting apparatus 10 goes to the step S401 and waits for generation of a next RTC interrupter. When it is the close time notifying signal of the store, the shopping information collecting apparatus 10 checks at step S403 whether forwarding data are received from a child node in case that there is the child node.

At a check result of the step S403, when the forwarding data are not received, the shopping information collecting apparatus 10 checks at step S404 whether there is sensing information to be transmitted to a neighboring parent node when there is a parent node, a repeater when there is no parent node, but the repeater, or directly to the shopping information analyzing server when there is no parent node or repeater.

The shopping information collecting apparatus 10 where there is no child node, the logic flow goes to the step S404.

At a check result of step S404, when there is sensing information to be transmitted to the neighboring parent node, the repeater or the shopping information analyzing server 20, the shopping information collecting apparatus 10 transmits own sensing information at step S405, and converts a normal mode into a sleep mode at step S406.

At a check result of the step S404, when there is no sensing information to be transmitted to the neighboring parent node, the repeater or the shopping information analyzing server 20, the shopping information collecting apparatus 10 directly converts a normal mode into a sleep mode at step S406.

When an RTC interrupter is generated at step S407, the shopping information collecting apparatus 10 converting the normal mode into the sleep mode checks whether the RTC interrupter is an open time notifying signal of the store at step S408.

At a check result of the step S408, when it is not the open time notifying signal of the store, the shopping information collecting apparatus 10 goes to the step S407 and waits for generation of a next RTC interrupter. When it is the open time notifying signal of the store, the shopping information collecting apparatus 10 converts the sleep mode into the normal mode at step S409.

At a check result of the step S403, when forwarding data are received, the shopping information collecting apparatus 10 checks whether there is own sensing information to be transmitted to the neighboring parent node, the repeater or the shopping information analyzing server 20 at step S410.

At a check result of the step S410, when there is own sensing information to be transmitted to the neighboring parent node, the repeater or the shopping information analyzing server 20, the shopping information collecting apparatus 10 combines and transmits own sensing information and the received forwarding data at step S411, goes to the step S406 and converts the normal mode into the sleep mode.

At a check result of the step S410, when own sensing information to be transmitted to the neighboring parent node, the repeater or the shopping information analyzing server 20 does not exist, the shopping information collecting apparatus 10 transmits only the received forwarding data at step S412, goes to the step S406 and converts the normal mode into the sleep mode.

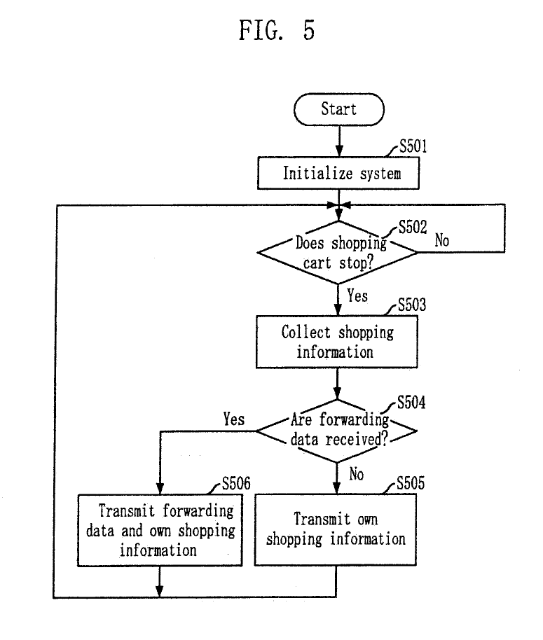

FIG. 5 is a flowchart describing a shopping information collecting method in accordance with an embodiment of the present invention.

When the shopping information collecting apparatus converts the sleep mode into the normal mode, the shopping information collecting apparatus 10 initializes pre-processed shopping information such as information on the number of shopping carts, the possessing time and the usage time zone of the shopping cart at step S501.

The shopping information collecting apparatus 10 checks in real-time whether the shopping cart stops within own zone at step S502, and collects the shopping information when the shopping cart stops within the zone at step S503.

When there is a child node, the shopping information collecting apparatus 10 checks whether shopping information, i.e., forwarding data, is received from the child node at step S504.

The shopping information collecting apparatus 10 having no child node directly goes to the step S505 without passing the step S504.

At a check result of the step S504, when the forwarding data are not received, the shopping information collecting apparatus 10 transmits own shopping information collected at the step S503 to the neighboring parent node when there is the parent node, the repeater when there is no parent node but there is the repeater, or directly to the shopping information analyzing server 20 when there is no parent node or the repeater at step S505.

At a check result of the step S504, when the forwarding data are received, the shopping information collecting apparatus 10 combines the received forwarding data and own shopping information collected at step S503 and transmits the combined forwarding data and shopping information to the neighboring parent node, the repeater or the shopping information analyzing server 20 at step S506.

As described above, the technology of the present invention can be realized as a program. A code and a code segment forming the program can be easily inferred from a computer programmer of the related field. Also, the realized program is stored in a computer-readable recording medium, i.e., information storing media, and is read and operated by the computer, thereby realizing the method of the present invention. The recording medium includes all types of recording media which can be read by the computer.

While the present invention has been described with respect to certain preferred embodiments, it will be apparent to those skilled in the art that various changes and modifications may be made without departing from the scope of the invention as defined in the following claims.

### INDUSTRIAL APPLICABILITY

The present invention can be used to a shopping information collect system.

What is claimed is:

1. An apparatus for collecting shopping information, comprising:
a magnetic value sensing and analyzing means for sensing and analyzing a magnetic value within own zone in real-time;
a central processing means for processing shopping information based on the magnetic value analyzed by the magnetic value sensing and analyzing means; and
a shopping information transmitting means for transmitting shopping information processed by the central processing means.

2. The apparatus of claim 1, further comprising:
a Real Time Clock (RTC) processing means for providing store open and close time information; and
a power control means for controlling power based on open and close time information from the RTC processing means.

3. The apparatus of claim 2, wherein the power control means converts a normal mode into a sleep mode based on the store close time information provided from the RTC processing means, and converts a sleep mode into a normal mode based on the store open time information provided from the RTC processing means.

4. The apparatus of claim 2, further comprising:
a data storing means for storing shopping information processed by the central processing means.

5. The apparatus of claim 1, wherein the magnetic value sensing and analyzing means includes:
a magnetic value sensing unit for sensing the magnetic value within own zone in real-time and converting the magnetic value into a digital signal; and
a digital signal analyzing unit for analyzing the digital signal converted by the magnetic value sensing unit and transmitting the digital signal to the central processing means.

6. The apparatus of claim 5, wherein the shopping information transmitting means includes a wireless data processing unit for transmitting the shopping information transmitted from the central processing means to a Radio Frequency (RF) signal processing unit; and
the RF signal processing unit for converting and transmitting the shopping information transmitted from the wireless data processing unit into an analog signal.

7. The apparatus of claim 6, wherein the RF signal processing unit transmits the forwarding data to the wireless data processing unit by receiving the shopping information of a child node, which is called forwarding data, from the child node, and the wireless data processing unit combines the forwarding data transmitted from the RF signal processing unit and the shopping information transmitted from the central processing means, and transmits the combined forwarding data and shopping information to the RF signal processing unit.

8. The apparatus of claim 7, wherein the RF signal processing unit transmits the combined forwarding data and shopping information to any one of the parent node, the repeater or the shopping information analyzing server.

9. The apparatus of claim 1, wherein when the magnetic value analyzed by the magnetic value sensing and analyzing means exceeds a pre-defined threshold and the exceeded magnetic value is sensed continuously more than predetermined times, the central processing means determines that the shopping cart stops within own zone.

10. The apparatus of claim 9, wherein the central processing means calculates the number of shopping carts stopping within own zone on the basis of threshold.

11. The apparatus of claim 10, wherein the central processing means calculates a possessing time and a usage time zone of the shopping cart based on a time that the shopping cart stopping within own zone is sensed and a time that sensing the shopping cart ends.

12. The apparatus of claim 1, wherein the shopping information includes at least one of information on the number of shopping carts, and the possessing time and usage time zone of the shopping cart.

13. The apparatus of claim 1, wherein own zone is a zone that the magnetic value sensing and analyzing means can sense the magnetic value and own zone is set up not to be overlapped with the sensing zone of a neighboring shopping information collecting apparatus.

14. A method for collecting shopping information, comprising the steps of:
initializing pre-processed shopping information;
checking whether a shopping cart stops within own zone based on a magnetic value sensed in real-time and collecting information on the shopping cart; and
transmitting the collected shopping information.

15. The method of claim 14, further comprising the steps of:
converting a mode into a normal mode based on store open time information and going to the step of initializing the pre-processed shopping information; and
converting a mode into a sleep mode based on store close time information.

16. The method of claim 15, further comprising the step of:
storing the collected shopping information.

17. The method of claim 14, wherein the step of collecting the shopping cart information includes the steps of:
sensing a magnetic value in real-time and recognizing a shopping cart stopping within own zone;
counting the number of shopping carts stopping within own zone; and
calculating a possessing time and a usage time zone of the shopping cart stopping within own zone.

18. The method of claim 17, wherein the step of transmitting the shopping information includes the steps of:
checking whether shopping information, which is called forwarding data, is received from a child node;
at a check result, when the forwarding data are not received, transmitting the collected shopping information; and
at a check result, when the forwarding data are received, combining and transmitting the received forwarding data and the collected shopping information.
